(19) United States
(12) Patent Application Publication
(10) Pub. No.: US 2017/0076290 A1
(43) Pub. Date: Mar. 16, 2017

(54) SYSTEM AND METHOD FOR PERFORMING PAYMENTS FROM A VEHICLE

(71) Applicant: Sten CORFITSEN, Stockholm (SE)

(72) Inventor: Sten CORFITSEN, Stockholm (SE)

(21) Appl. No.: 15/310,752

(22) PCT Filed: May 12, 2015
(86) PCT No.: PCT/SE2015/050539

§ 371 Date: Nov. 12, 2016

(30) Foreign Application Priority Data
May 16, 2014 (SE) 1450575-4

(51) Int. Cl. G06Q 20/40; G07F 13/02; G07F 15/00

(52) U.S. Cl. CPC G06Q 20/4012; G07F 15/005; G07F 13/025; Y02T 90/128

(57) ABSTRACT

Method for making payments from a vehicle (180) in connection to the delivery of goods and/or services to the vehicle (180) in question at a station (110). The method comprises to register a user (183) as well as the vehicle, including a registration number, and to associate the user with the vehicle in a central data base (151); when the user drives the vehicle up to the station, to identify the vehicle by a visual readout of a license plate on the vehicle; to receive a confirmation from the user, the confirmation being input via a mobile communication device of the user; and allowing the delivery of the said goods and/or services and charging the user using a payment channel (160) specified for the user.

The present invention relates to a system and a method for performing payments from a vehicle in connection to the delivery of goods or services to the vehicle. In particular, the invention relates to such a system and such a method for making payments in connection to the filling of fuel, charging the battery or replacing a battery in a vehicle, especially in connection to a procedure for such automatic refilling, loading or replacement being carried out for the vehicles in question.

At petrol stations and other permanent installations for fuel refilling and/or charging of electric power for electric vehicles, conventionally a mode of payment is used that requires a vehicle driver to get out of the car, or at least to physically interact with an apparatus arranged outside of the vehicle. Examples include automatic card payment machines, in which a credit or debit card typically must be registered before any service can be delivered to the vehicle; and manual payments at an attended cashier. This also applies to previously described stations for automatically changing batteries in electrical vehicles.

It is furthermore known to use an interaction device which is fixedly arranged in a vehicle for communicating with a fixed payment device installed in for instance a petrol station.

The prior art includes, for example, DE 102009049754 A1, wherein the vehicle is put in communication with a petrol station at which the vehicle is parked, after which the driver can order propellant after having first indicated certain data concerning the vehicle, such as its registration number. A visual verification is accomplished of the vehicle itself before payment is effectuated. Additionally, the authentication of the payment is performed over the mobile network in direct communication with the driver's mobile phone.

Furthermore, there is described, for example in EP 2447905 A1, services for renting car using a portable electronic device.

U.S. Pat. No. 5,862,222 A describes a method for automatic refuelling, wherein personal information regarding the driver is used for verification.

U.S. Pat. No. 7,513,419 describes a method in which a vehicle is identified by a camera before cash payment is performed.

It is also known to visually identify the vehicle itself using the unique license plates of the vehicles.

At stations where fuel is refilled, or where batteries are recharged or replaced, in an automatic way, there is a problem to provide easy yet secure payment of the received product, both without the driver having to go out of the vehicle or to physically interact with equipment installed externally to the vehicle. It is desirable for such a solution not to require extensive, or even any, modification of the vehicle in question to be compatible with the station in question. It is also desirable for several drivers to be able to pay for products delivered to the same vehicle, and, contrary, for the same driver to be able to pay for products delivered to a specific one of multiple different vehicles, still in as simple and safe a way as possible.

The present invention solves the above described problems.

Hence, the invention relates to a method for making payments from a vehicle in connection to the delivery of goods and/or services to the vehicle in question at a station, wherein said goods and/or services are delivered to the vehicle automatically by equipment comprised in the station, which method is characterized in that the method comprises the steps of a) registering a user in a central database; b) registering the vehicle in the central database, including a registration number for the vehicle; c) associating the user with the vehicle in the central database; d) when the user drives the vehicle up to the station, identifying the vehicle by a visual readout of a license plate on the vehicle and automatic matching between identified alphanumeric characters on the scanned license plate and the stored registration number; e) receiving a user confirmation, the confirmation being input via a mobile communication device of the user, and confirming that an association exists between the user and the vehicle in the central database; and f) if such an association exists, allowing the delivery of the said goods and/or services and charging the user using a payment channel specified for the user.

Moreover, the invention relates to a system for making payments from a vehicle in connection to the delivery of goods and/or services to the vehicle in question at a station, which system is arranged to deliver said goods and/or services to the vehicle automatically using equipment comprised in the station, which system is characterized in that the system comprises a central server, which server is arranged to register, in a central database, a user and the vehicle, including a registration number for the vehicle, as well as associating, in the database, the user to the vehicle, in that the system further comprises a visual reading device arranged to, when the user drives the vehicle up to the station, identify the vehicle by visual readout of a license plate on the vehicle, in that the central server is arranged to then automatically match identified alphanumeric characters on the read license plate to the registration number stored in the database, in that the server is arranged to receive a confirmation from the user, said confirmation being input using a mobile communication device of the user, and to verify that an association is stored between the user and the vehicle in the central database, and in that the server is arranged to, if such an association has been stored, allow the delivery of the said goods and/or services and to charge the user using a payment channel specified for the user.

In the following, the invention will be described in detail, with reference to exemplifying embodiments of the invention and to the accompanying drawings, wherein:

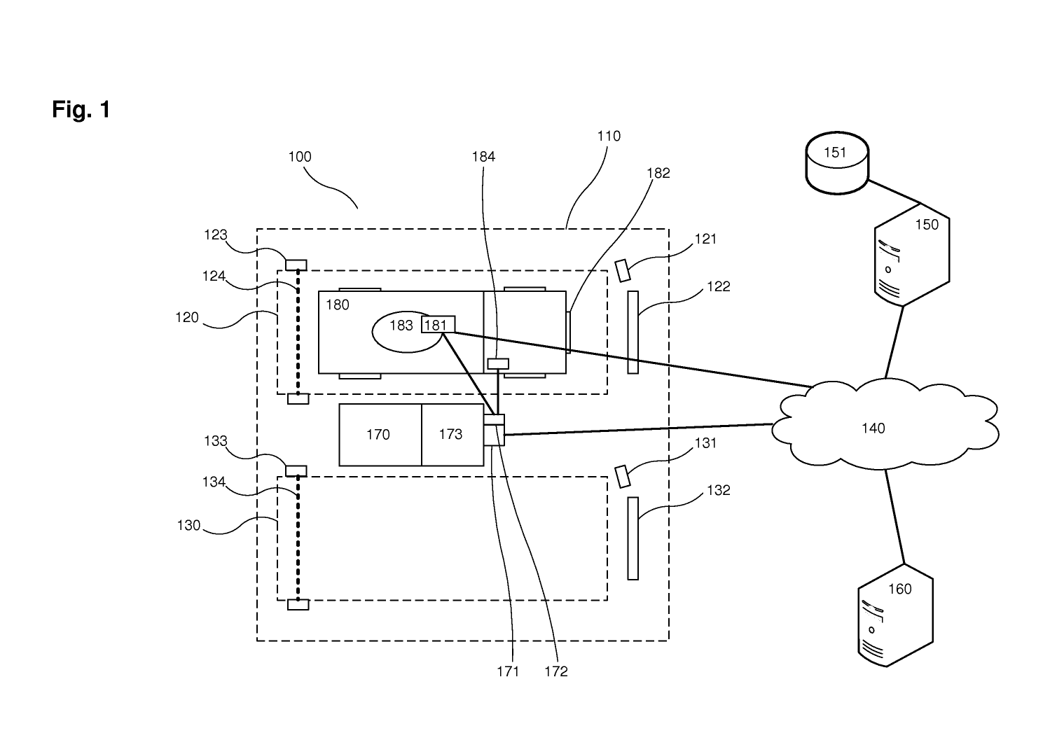

FIG. 1 is a schematic outline diagram of a system according to the present invention, arranged to perform a method according to the invention; and

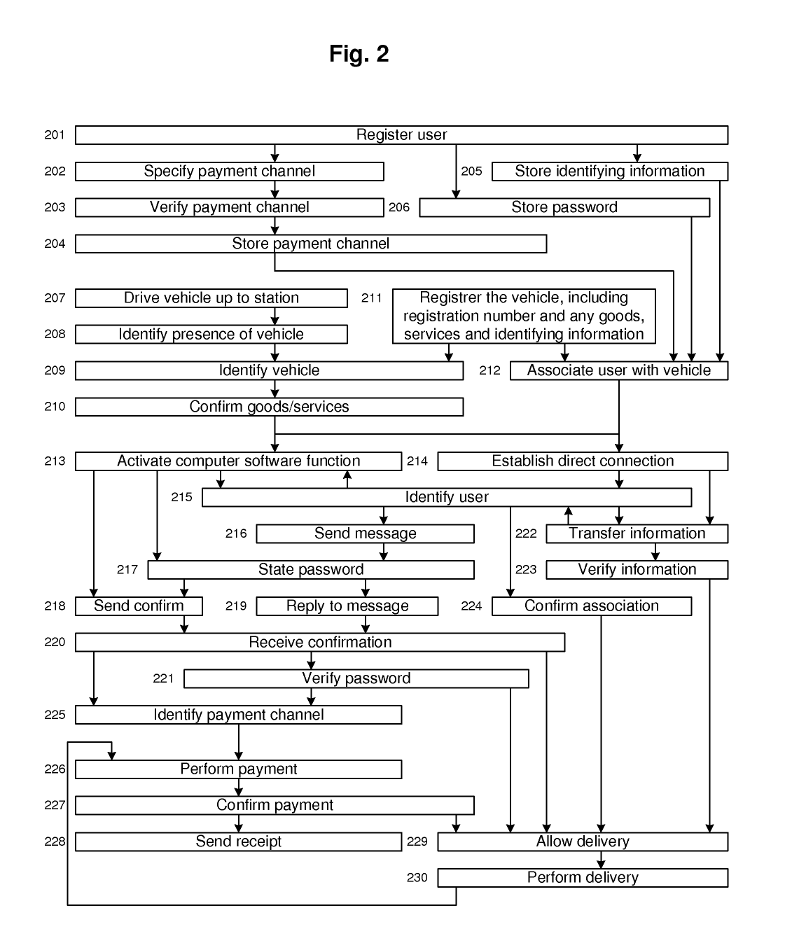

FIG. 2 is a flow chart of a method according to the present invention.

Hence, FIG. 1 thus illustrates a system 100 according to the invention, comprising a station 110 at which the goods and/or services can be delivered to a vehicle 180 which is driven up to and preferably is parked at one 120 of preferably several available sites 120, 130 at the station 110 for the delivery of goods and/or services to the vehicle at the site in question.

The system further includes a delivery unit 170 for the said goods and/or services. In a preferred embodiment, the goods and/or services comprises the refilling of fuel to the vehicle in question, charging a battery of the vehicle in question, and/or replacement of a battery of the vehicle in question. In this case, the delivery unit 170 is preferably comprised of, or comprises, a gas pump, a charging station for electric vehicles and/or a station for replacing a battery of electric vehicles.

Hence, in this case the word “service” is exemplified by the delivery of electrical energy and/or the provision of a fully charged battery, while the word “product” is exemplified by a fuel, such as a liquid fuel, such as petrol or a gaseous fuel, such as biogas. It is understood that other goods and/or services can also be delivered, such as washer fluid and vehicle cleaning (car wash). Combinations of such products and/or services can also be delivered by the device 170. Preferably, the supply device 170 is arranged for fully automatic supply of goods and/or services. For example, the device 170 may be arranged, in a known manner, to automatically locate a fuel delivery location of the vehicle 180 to which fuel is to supplied in a fully automatic manner via a nozzle; to automatically locate a battery and to replace the battery with a charged one; or to automatically identify the space occupied by the vehicle and then to automatically perform a washing of the vehicle. Such methods are known as such, and are not described more fully herein.

The station comprises a respective display 122, 132 per delivery site 120, 130, and a respective visual reading device in the form of a camera 121, 131 per delivery site 120, 130. The displays 122, 132 are arranged to display information about the advancement of the present method to a user 183 who is in the vehicle 180. They can also display instructions to the user 183 as to what the user 183 is expected to do at various times during the procedure. The cameras 121, 131 are arranged to visually observe vehicles present at each delivery site 120, 130, to perform conventional image processing of captured images and to, in a known way, interpret digitally stored information from the image-processed material regarding the vehicle in question.

Each respective delivery site 120, 130 comprises a respective locating or activating means 123, 133, such as a light switch arranged to be activated when a respective light beam 124, 134 is broken. The respective means 123, 133 is arranged to sense the presence of a vehicle at, or the passage of a vehicle into, a given one of said delivery sites 120, 130 for delivery of said goods and/or services to the vehicle in question. Preferably, the means 123, 133 are also arranged to sense the more exact location of the vehicle in a known manner, such as by a laser sensing means. Furthermore, the means 123, 133 are preferably connected to the central unit 173 (below), so that the user 183 is alerted, such as via instructions displayed to the user 183 on the respective display 122, 132, when the vehicle 180 is to be stopped at the correct position in relation to delivery device 170.

A central unit 173 of the station 110, for operation of the method according to the invention, is preferably connected to a nearfield communication device 172 arranged at the station, such as a transponder for NFC, RFID, Bluetooth, WiFi or any other conventional wireless communication standard that works at close range rather than across long distances, such as at a maximum distance of 100 meters, more preferably not more than 20 meters. The device 172 is arranged to communicate directly with a mobile communication device 181 of the user 183 in the vehicle 180.

In a preferred embodiment, there is also installed a fixed communication device 184, preferably a passive near field communication device, such as a passive RFID antenna, at the vehicle 180. The device 184 is arranged to communicate with the station 110, for example via the device 172.

The central unit is also, in addition to the displays 122, 132 and the cameras 121, 131, connected to a communication device 171 which in turn is connected to the Internet 140 and thus to a central server 150.

This central server 150 is also connected to the internet, and is itself connected to or comprises a central database 151. In addition, an as such conventional payment service provider 160 is also present, and connected to the Internet 140. In an important embodiment of the invention, the central server 150, which itself may indeed be implemented in a geographically distributed manner, is connected to several stations of the type described herein and as illustrated in FIG. 1. A user account or a vehicle registered by the server 150 may thus use the present method at all these connected stations (see below).

FIG. 2 illustrates a method according to the present invention schematically, wherein various preferred and in some cases alternative embodiments are shown. The arrows illustrate the preferred event sequences involving different method steps 201-230. It will be appreciated that reference numerals 201-230 in themselves do not imply any specific order in terms of the individual method steps.

Thus, the method concerns a way to make payments from a vehicle 180 in connection to the delivery of goods and/or services to the vehicle 180 in question at a station 110, said goods and/or services being delivered to the vehicle 180 automatically by equipment 170 comprised in the station 110.

In a step 201, a user 183 is registered in the central database 151. This is preferably performed from a distance, such as by the user 183 being given access to an interface directly at or in relation to the server 150, or through another central unit, such as a web server (not shown) which in turn is connected to the server 150. In a preferred embodiment, first a secure (encrypted) digital connection is established between the mobile device 181 and the central server 150, and thereafter the below-described user 183 information is then transferred over the secure connection upon the registration in step 201.

In a step 211, which may be performed before, but preferably after step 201, a vehicle 180 is registered in the central database 151, which registration takes place in a manner similar to that of step 201. The registration of the vehicle 180 comprises that information regarding a registration number 182 of the vehicle 180 is transferred to the database 151 and stored therein. It is also preferred that the step 211 comprises that data regarding specific goods and/or services that can be delivered to the vehicle in question is identified, as supplied by the user or received from an external information provider, and is stored in the central database 151, as well as is associated with the vehicle in question. A desired normal delivery, such as “full tank of petrol” can advantageously also be recorded for the vehicle in question 180 in the database 151.

Moreover, the step 211 preferably comprises registration of identifying information regarding the vehicle 180, in addition to its registration number 182. Such additional identifying information may comprise hallmarks of the vehicle 180 that are visible externally on the vehicle 180, such as a car model, paint colour or visual characteristics that have been applied to the vehicle 180 in advance for use in the present method. Such visual characteristics may be for example be comprised by a visually readable adhesive label with a predetermined pattern, such as a QR code. This registration can also be done in a separate step after step 211 for a particular vehicle.

In a step 212, a user 183, who has been registered in the database 151, is associated with a specific vehicle 180 which has been registered in the database 151, which means that the system receives, and the database 151 stores, knowledge that the user 183 in question can validly utilize the present method when the user 183 is in the vehicle 180 in question.

For a method according to the present invention, it is preferred that multiple users can be registered, and are also actually registered, in the database 151, and/or that several vehicles can be registered, and are also actually registered, in the database 151. It is further preferred that at least two such users are associated, and are in fact associated, with one and the same vehicle 180. It is also preferred that at least two such vehicles can be associated, and are in fact associated, with one and the same user 183. These different associations can be performed in a single step 211, but they can also be performed at different times for different users and/or vehicles.

The association is preferably initiated by a user, and in a manner, preferably via a secure connection, which is similar to that described above in connection to steps 201 and 211.

Preferably, one, or alternatively several different, payment channel(s) are specified 202 and verified 203 for the user 183 in connection to the registration in step 201 or thereafter. Such payment channels may for instance comprise data regarding valid debit or credit cards belonging to the user 183 in question, or the expression of a desire of the user to be invoiced retroactively, in which case the registration may mean that address information and so on is specified and stored in the database 151. The verification 203 means, as applicable, that the payment channel's validity and availability is verified using the information provided by the user 183. If the verification 203 is successful, the payment channel is stored in a step 204 in the database 151 for the user 183 in question.

Similarly in connection to, or after, step 201, information identifying the user's 183 mobile communication device 181 is stored in a step 205. Such identifying information may comprise an IMSI (International Mobile Subscriber Identity) for a SIM card (Subscriber Identity Module) of the device 181, or an MSISDN of the device 181, and preferably uniquely identifies the device 181. In a preferred embodiment, a piece of specific computer software, which is executed on or from the device 181, such as via a web service, is used for the registration in step 201. In this case, it is preferred that the identifying information is transmitted to the server 150 and the database 151 automatically in connection to the registration of said piece of computer software.

Furthermore, it is preferred that the user 183 registers a password such as a PIN code, which in step 206 is stored in the database 151 in association with the user 183.

In a step 207, the user 183 drives the vehicle 180 forward, up to the station 100 and a particular delivery site 120 at the station 110. In a step 208, the presence, and preferably also the location, of the vehicle 180, which in this state preferably stands still and is parked, is then preferably identified using the activation means 123, by or at the delivery site 120 for delivery of the said goods and/or services to the vehicle 180.

In a step 209, the identity of the vehicle 180 is then determined. According to the invention, this is done by visually reading, by the camera 121, a license plate 182 which is mounted on the vehicle 180, and the automatic matching between identified alphanumeric characters of the scanned license plate 182 and the registration number for the vehicle 180, which was registered and stored in the database 151 in step 211. It is preferred that this matching is performed by the central server 150, which in communication with the central unit 173 indicates whether the vehicle 180 can be identified or not.

Furthermore, a preferred embodiment step 209 comprises, in order to further increase the safety of a method according to the invention, visually identifying, with the help of the camera 121 and digital imaging technology as described above, and adequately interpreting visually visible characteristics of the vehicle 180 of the types described above and recorded in step 211. Thus, the identification of the vehicle 180 in this case comprises that said visible characteristics are read visually and matched, by the server 150, to one or several respective registered such visible sign, and the identification of the vehicle 180 succeeds only if said identifiers actually match.

If the vehicle 180 cannot be identified, the user 183 is informed via the display 122, and the method is interrupted.

In the corresponding way, after the vehicle 180 has been identified, in a step 210 a check and a confirmation that the goods and/or services previously recorded for the vehicle 180 in the database 151, in step 211, can be delivered at the station 110, and especially at the delivery site 120. If not, the user is notified 183 of the display 122, and the method is interrupted.

Thereafter, method steps 213-224 are performed for receiving a confirmation from the user 183, concerning the supply of certain goods and/or services, as well as that payment is to be made for delivered goods and/or services. According to the invention, this confirmation does not take place via a direct or indirect connection between the mobile communication device 181 or the vehicle 180 and the station 110, but via a connection between the mobile device 181 and the central server 150, preferably via a communication link, such as mobile internet over GPRS, which is completely independent of the station 110 as such.

Hence, in a step 215 the user 183 in the vehicle 180 is identified. This can be done in two different preferred ways, which may also be combined for increased security.

According to a first preferred way to identify the user, in a step 214 and between the communication device 172 in the station 110 and the mobile device 181, a direct communication link is established, the establishment of which implies that the central unit 173 becomes aware of the mobile device's 181 local presence and identity. This may be done by the above-discussed identifying information of the mobile communication device 181, which is possibly stored in the database 151, being transmitted 222 to the station 110 from the device 181 and via said direct communication link. Herein, the term “direct communication link” is intended to comprise the wireless near field communication techniques of the types discussed above.

It is, however, also possible that the direct communication link identifies the mobile device 181 in other ways, such as through communication from a piece of specific computer software executed on or from the mobile device 181 of a code that identifies the device 181, via a specific API (Application Programming Interface) provided by the device 172 or the central unit 173.

The direct communications link itself can also automatically imply an identification, such as by using a stated name for the device 181 during mating with the device 172 using Bluetooth.

It is preferred that, in a step 223, the above described and stored identifying information is compared to identifying information which was stored in the database 151 and associated with the user 183 in step 205. If the information does not match, the user 183 is informed via the display 122, and the process is interrupted.

According to a second preferred procedure of identifying the user, in a step 213 a computer software function that is executed on or from the mobile device 181 is activated. The software function may comprise a piece of computer software which is locally into stalled and executed on the device 181, which is initiated by the user 183; or a centrally executed piece of computer software which is initiated by the user 183 via the mobile device 181, such as via a website using HTML version 5. The computer software function is preferably arranged to provide the user 183 with a graphical user interface through which the user 183 can control the said computer software and, as applicable, input information data for transmission to the central server 150.

The software function that is indicated in FIG. 1 in the step 213 may alternatively or additionally comprise a piece of computer software which is executed centrally on the server 150, arranged to send a message to the user 183 in step 216 (see below). In this case, the user 183 is first identified, in the step 215, after which the step 216 is performed with respect to the thus identified user 183.

Said executing computer software function is preferably arranged to send to the central server 150, in a step 218, the delivery confirmation from the user 183.

Hence, according to this preferred embodiment said delivery confirmation from the user 183 is fetched by the user 183 activating the computer software function, which is thus then executed on or from the mobile communication device 181, which activation results in that the confirmation is sent 218 in a way that allows identification, in the server 150, of the transmitting mobile communication device 181. It is particularly preferred that the computer software function presents the user 183 with a user interface, such as a graphical user interface, on a display of the mobile device 181, via which the user 183 may input a password, such as a PIN. The entered password is transmitted, in step 218, together with the confirmation, to the central server 150.

Thus, the user 183 may, in connection to the vehicle 180 being driven up to and parked at the delivery site 120, activate the computer software function in the mobile device 181, which then transmits, preferably automatically at said activation, and possibly after having requested a password, a delivery confirmation to the server 150. This gives the server 150 the knowledge that the user 183 is currently prepared to, in his or her vehicle 180, receive a supply of certain goods and/or services.

As an alternative to the user-initiated confirmation, after the user 183 has been identified in one way or the other, a server-initiated confirmation routine can be performed, wherein the delivery confirmation is instead obtained from the user 183 by a message being sent, in a step 216, to the mobile communication device 181, and whereby the user 183 replies in an electronic and digital manner, to the central server 150, to the message, in a step 219, which response then constitutes the confirmation. In this case, it is preferred that, in connection to step 201, at least one contact record for an electronic, digital, communication channel, is registered for the user 183, selected from a phone number which is used in step 216 to send an SMS message (Short Message Service); an e-mail address used in step 216 to send an e-mail message; or an address used by an API (Application Programming Interface) provided by a piece of computer software executing on or from the mobile communication device 181, and which API is arranged to receive a message of said type. This registration may be similar to that described above in steps 205 and 206.

It is preferred that, in this case, the confirmation is obtained from the user 183 by the user 183 responding, in the step 219, to the message through the same communication channel as is used for transmitting, in step 216, the message.

It is preferred that such a response 219 comprises a password, such as a PIN code, which is input in step 217. This password corresponds in every way to the password which is transmitted to the server 150 in step 218, and may for example be input by the user as a part of the message text in a SMS or e-mail message being sent in step 219, or alternatively it can be entered through a user interface provided by said piece of computer software which receives the message in step 216.

In a step 220, the central server 150 receives the delivery confirmation from the user's 183 mobile device 181, together with a possible password specified in the received message 218 or 219. If such a password is required, because of the current security policy for the method, it will be verified, in a step 221, that the password is consistent with the password stored in the database 151 since step 206. If not, the user is notified 183, for example via the display 122, and the method is interrupted, or the user is given a renewed opportunity to enter the password correctly, by the method jumping back to step 217.

According to the invention, the method does not continue to neither step 225, nor step 229, before the said confirmation, which confirmation has thus been input via the mobile communication device 181 and received from the user 183.

After the user has been identified, in step 215, it is also verified, by the server 150, that the identified user 183 and the vehicle 180 located by or at the delivery site have previously been associated with each other, in the step 212, in database 151. If such an association is missing, this is preferably notified to the user 183, for instance via the display 122, and the method is interrupted.

If, on the other hand, such an association exists in the database 151, the delivery of the said goods and/or services is allowed, in a step 229, and the user is charged, in a step 225, using the payment channel specified for the user 183 in the step 202.

Thus, the user 183 drives the vehicle 180 up to the delivery site 120, where the vehicle 180 is visually identified and possibly also identified in other ways. In connection to this, the user 183 is preferably also identified, preferably by sending an acknowledgement to the central server 150 but possibly instead through direct contact with the station 110. It is preferred that the method, in order to proceed to the steps 225 and 229, does not allow more than about 5 minutes, preferably not more than about 1 minute, between the identification of the vehicle 180 and the identification of the user 183. This way, the association between them in step 224 is performed with reasonable certainty, even if multiple users are crosswise associated with several vehicles. As an alternative or supplement thereto, information is preferably provided to the user 183, via the mobile device 181 and the server 150, about the station 110 and/or the identity of the delivery site 120 in connection to the presentation of the above-mentioned interface to the user 183 on the device 181 in the step 218, or as a part of the message sent in step 216. As a result, the user 183 can verify that it really is in relation to the correct vehicle 180 that the confirmation is sent.

The user 183 may also, as a part of the said interface which is presented by said computer software function and used to send the confirmation in step 218, or as additional information comprised in the response sent in step 219, specify which goods and/or services that are desired for delivery to the vehicle 180.

However, it is preferred that the delivery site 120 is associated with one particular good or service, and that the delivery device 170 is arranged to perform the good or service in a certain predetermined quantity, such as “full fuel tank,” “full charge of the battery” or “a washing”. This way, the user 183 confirmation is sufficient for the good or service to be delivered, which is especially easy for the user. Alternatively, it is preferred that the user 183, in step 211, indicates a single service or good (such as “petrol”), with a single specified quantity (such as “full tank”), which is then always delivered in a straightforward manner without the user 183 first having to choose from different available goods, services or quantities.

It is, for similar reasons, preferred that no additional credentials are required from the user 183 in connection to the payment for the goods and/or services performed. Payment is made in a step 226, following step 225, in which a preferred payment channel for the user 183 in question is identified, which payment channel has been specified in the step 202. Instead, the credentials given in step 202 are used, if such are necessary to effect the payment. Hence, this communication takes place in steps 225 and 226, between the server 150 and the payment intermediary 160, preferably without intervention of the user 183.

Specifically, it is preferable that, in steps 225-227, the charge for the goods and/or services takes place without the user 183 is requested to specifically approve the debited amount as such.

In a step 228, an electronic receipt is then preferably sent to a recipient address, such as the destination address to which the message was sent in step 216, which address was registered in the database 151 and associated with the user 183 in question in connection to step 201.

The actual delivery of the goods and/or services are allowed, in a step 229, possibly after the payment is confirmed but, alternatively, after the credentials as such have been verified as valid at the payment intermediary 160 by the server 150. Specifically, it is preferred, especially when buying goods and/or services for which the total amount is unknown before the delivery has been made, such as is the case when purchasing petrol, that the delivery is first performed, in the step 130, after which the payment is made in step 226. In this case, step 225 also comprises the verification that valid credentials are available for the user 183 in question, and that the delivery is not allowed if this is not so.

If delivery is permitted, the delivery in question is then also performed, in a step 230, in a known automatic way, without the user 183 having to get out of the vehicle 180. Then, the user 183 leaves the station 110 in the vehicle 180.

Such a system and method enables a user 183 to, after a simple registration step which can be performed remotely and when so is convenient for the user 183, simply drive his or her vehicle 180 to a station 110 and a particular delivery site 120 for a particular good or service, such as petrol. Once there, the user 183 easily confirms, such as by launching a specific piece of computer software on his or her mobile device 181, and possibly by entering a password, or replying to a message, such as an SMS message, which is automatically transmitted upon the initiative of the server 150, his or her presence and that delivery of the goods and/or services is desired. The delivery is performed, and the user 183 receives an electronic receipt. The user 183 thus does not need to get out of the vehicle 180, interact with any staff or remember complicated credential information. In addition, the method also works even in the case of a family with two adults having two cars, or even in a car pool comprising many users and vehicles, without the user 183 having to explicitly specify which vehicle 180 is currently driven, or which user that for the moment is driving the vehicle.

A single such central registration also automatically implies that the method works at all stations being connected to the server 150.

Above, preferred embodiments have been described. However, it is apparent to the person skilled in the art that many changes can be made to the described embodiments without departing from the basic idea of the invention.

For example, other types of goods and/or services may be delivered by the delivery device 170. Other channels than those specified for the step 216 may be used. Moreover, different types of security measures, such as a combination of steps 218, 219 and 223, may be used to further enhance security.

The station 110 is preferably permanently installed, and is preferably a petrol station or the like, but it will be appreciated that temporary filling stations for fuel or the like can also be installed using a method according to the present invention, by simply installing the camera 121 and the display 122, possibly the activating means 123 and the connection to the server 150. In this way, even an existing station 110 can, in a simple and inexpensive way, be supplemented with such equipment in order then to be used in a method according to the present invention.

Furthermore, the above-discussed interface presented to the user 183 of the mobile device 181 may conveniently be used to increase the flexibility of the method according to the invention. For example, temporary offers, discounts and similar can be presented to the user 183, who in turn easily can accept such tenders through the delivery confirmation. In addition, the interface may be used for additional sales on-site, in a flexible and user accessible way, for example while the goods and/or services are being delivered to the vehicle 180.

Thus, the invention is not limited to the described embodiments, but can be varied within the scope of the enclosed claims.

1. Method for making payments from a vehicle in connection to the delivery of goods and/or services to the vehicle in question at a station, wherein said goods and/or services are delivered to the vehicle automatically by equipment comprised in the station, the method comprises the steps of
a) registering a user in a central database;
b) registering the vehicle in the central database, including a registration number for the vehicle;
c) associating the user with the vehicle in the central database;
d) when the user drives the vehicle up to the station, identifying the vehicle by a visual readout of a license plate on the vehicle and automatic matching between identified alphanumeric characters on the scanned license plate and the stored registration number;
e) receiving, via a communication channel which is independent of the station itself, a user confirmation, the confirmation being input via a mobile communication device of the user, and confirming that an association exists between the user and the vehicle in the central database; and
f) if such an association exists, allowing the delivery of the said goods and/or services and charging the user using a payment channel -specified for the user.

2. Method according to claim 1, wherein, in step d), it is first identified that a vehicle is present at a certain one of several available sites for delivery of said goods and/or services to vehicles, and that the identity of the said vehicle whose position has been identified is thereafter established using said visual reading of the license plate.

3. Method according to claim 1, in step a), several users are registered in the central database and, in step c), at least two users are associated with one and the same vehicle.

4. Method according to claim 1, wherein, in step b), several vehicles are registered in the central database and, in step c), at least two vehicles are associated with one and the same user.

5. Method according to claim 1, wherein, in step e), the confirmation is collected from the user by a message being sent to the mobile communication device and the user responding to the message, which response then constitutes the confirmation, and, in step a), at least one contact information is registered for the user, selected among a telephone number which is used in step e) to send an SMS (Short Message Service) message; an e-mail address used in step e) to send an e-mail; or an address which is used by an API (Application Programming Interface) which is provided by a piece of computer software executed on or from the mobile communication device and arranged for receiving a message of the said type.

6. Method according to claim 5, wherein the confirmation is collected from the user by the user responding to the message via the same communication channel as the one used to send the message.

7. Method according to claim 1, wherein, in step e), the confirmation is collected from the user by the user activating a computer software function executed on or from the mobile communication device, which activation results in the said confirmation is sent in a way making it possible to identify the sending mobile communication device.

8. Method according to claim 5, wherein the confirmation is comprised by the user inputting, via the mobile communication device, a PIN code or a password, which is received and compared to a corresponding PIN code or password which has been stored in step a) in the central database and associated with the user.

9. (canceled)

10. Method according to claim 1, wherein, in step a), which is performed before the vehicle is driven up to the station, the said payment channel is specified and verified for the user, and no additional credentials are required from the user in step f).

11. Method according to claim 10, wherein, in step f), the said charge takes place without the user having to specifically allow the charged amount.

12. Method according to claim 1, wherein, in step b), in addition to the registration number, at least one visible hallmark for the vehicle, visible on the exterior of the vehicle, selected among car model, paint color and a visual characteristic which has been applied to the vehicle beforehand with the purpose of being used in the present method, is registered, and, in step d), the identification of the vehicle comprises that the said visible hallmark is read visually and is matched to the registered visible hallmark, and, in step d), the vehicle is only identified if said hallmark matches.

13. Method according to claim 1, wherein the goods and/or services comprise filling of fuel, charging of a battery of the vehicle and/or replacement of a battery of the vehicle.

14. Method according to claim 1, wherein, in step b), data regarding specified goods and/or services that may be delivered to the vehicle are identified and stored in the central database, and associated with the vehicle.

15. System for making payments from a vehicle in connection to the delivery of goods and/or services to the vehicle in question at a station, which system is arranged to deliver said goods and/or services to the vehicle automatically using equipment comprised in the station, wherein the system comprises a central server, which server is arranged to register, in a central database, a user and the vehicle, including a registration number for the vehicle, as well as associating, in the database, the user to the vehicle, and the system further comprises a visual reading device arranged to, when the user drives the vehicle up to the station, identify the vehicle by visual readout of a license plate on the vehicle, and the central server is arranged to then automatically match identified alphanumeric characters on the read license plate to the registration number stored in the database, and the server is arranged to receive, via a communication channel which is independent of the station itself, a confirmation from the user, said confirmation being input using a mobile communication device of the user, and to verify that an association is stored between the user and the vehicle in the central database, and the server is arranged to, if such an association has been stored, allow the delivery of the said goods and/or services and to charge the user using a payment channel specified for the user.

16. System according to claim 15, wherein the system further comprises means for identifying that a vehicle is present at a certain one of several available sites for delivery of said goods and/or services to the vehicle, and said reading device is arranged to only thereafter identify the said vehicle the position of which has been identified by the identification means.

17. System according to claim 15, wherein several users have been registered in the central database, and at least two users have been associated with one and the same vehicle.

18. System according to claim 15, wherein the server is arranged to, in the central database, be able to associate at least two vehicles with one and the same user and at least two users with one and the same vehicle.

19. System according to claim 15, wherein the server is arranged to receive a confirmation from the user in the vehicle after the vehicle has been identified using the reading device.

20. (canceled)

21. System according to claim 15, wherein the goods and/or services comprise filling of fuel, charging of a battery of the vehicle and/or replacement of a battery of the vehicle.
